(19) United States
(12) Patent Application Publication
(10) Pub. No.: US 2008/0288673 A1
(43) Pub. Date: Nov. 20, 2008

(54) System-on-Chip Apparatus with Time Shareable Memory and Method for Operating Such an Apparatus

(75) Inventor: Dietmar Gassmann, Dresden (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/092,140

(22) PCT Filed: Oct. 24, 2006
(86) PCT No.: PCT/IB06/53910

§ 371 Date: May 5, 2008

(30) Foreign Application Priority Data
Nov. 2, 2005 (EP) 05110253.1

(51) Int. Cl. G06F 3/00; G06F 13/00; G06F 13/42

(52) U.S. Cl. 710/51; 710/106; 710/305

(57) ABSTRACT

The invention relates to a system-on-chip apparatus (1), comprising at least two electronic components (2, 3) serving for special purpose functions and a system bus (7) and at least one random access memory (9) that is integrated into the first electronic component (2), located in common on one substrate (8), wherein the system bus (7) connects the electronic components (2, 3) and wherein the random access memory (9) of the first electronic component (2) is time shareable to the second electronic component (3) via said system bus (7), and to a method for operating such a system-on-chip apparatus (1).

The invention relates to a system-on-chip apparatus, comprising at least two electronic components serving for special purpose functions, and to a method for operating such an apparatus.

A system-on-chip (shortly called SoC) apparatus is the packaging of all necessary electronic circuits, components and parts for a “system” such as for a cell phone or a digital camera on a single integrated circuit (IC), generally known as a microchip. The system-on-chip apparatus consists of general-purpose components like processor cores, bus-systems and memories as well as dedicated hardware components or hardware accelerators. For example, a system-on-a-chip apparatus for a sound-detecting device might include an audio receiver, an analog-to-digital converter (shortly called ADC), a microprocessor, a memory, and the input/output logic control for a user—all these components are on a single microchip.

Special purpose functions may be, for example, accelerated execution of tasks such as self-governed rendering of graphics, measuring of data or transmission of information.

System-on-chip (shortly called SoC or SoC) apparatuses are basically known in the prior art. For example, in US 2004/0010652 A1 a system-on-chip apparatus is described that includes at least a processor core and one or more peripherals that communicate on a first internal bus that carries signals having a latency tolerant signal protocol that enables an arbitrary number of pipeline stages between any signal initiator and any signal target. A shared memory subsystem, direct-memory-access-type (shortly called DMA) peripherals, and a second internal bus with a topology overlapping the first bus, may also be included. For the shared memory subsystem, an on-chip random access memory (shortly called RAM) is disclosed. All signals over both busses are point-to-point and registered and all transactions on both busses are handshaked. An arbitrary number of flip-flops, multiplexing routers, and/or decoding routers can be included between any signal initiator and any signal target on either bus, and may be added at any time during the design and layout of the system-on-chip.

In several appliances of systems-on-chips, peripherals or other electronic components that serve for special purpose functions need a resource of random access memory for performing their task. These dedicated components are often called hardware accelerators, because they are used to accelerate software functions or hardware logic.

For example, a graphics accelerator component usually uses an internal graphics memory for rendering graphics. Another possibility is to use a general purpose random access memory shareable between several components via a system bus as described in the publication mentioned above. Hence, either each electronic component that needs a memory resource has to be provided with its own built-in random access memory and/or an additional general purpose random access memory has to be provided on the chip. Each memory needs additional chip-area and means a higher leakage current for the chip.

In more detail, if memories are used within accelerators for example, these are tailored for their application and can not be used for any other purpose. This is an efficient way in case the components are always in use. However, complex system-on-chip apparatuses may support different standards or applications. One application may use a specific accelerator, while another one may need more general purpose memory for data storage. If a memory can not be used by both applications, the memory resource has to be provisioned twice, with one instance always not being used.

It is an object of this invention to specify an improved system-on-chip apparatus and an improved method for operating such a system-on-chip apparatus, wherein less random access memory facilities are necessary.

The problem is solved by a system-on-chip apparatus comprising the features given in claim 1 and by a method comprising the features given in claim 11.

Advantageous embodiments of the invention are given in the dependent claims.

According to the invention, a system-on-chip apparatus comprises at least two electronic components serving for special purpose functions and a system bus and at least one random access memory that is integrated into the first electronic component, located in common on one substrate, wherein the system bus connects the electronic components and wherein the random access memory of the first electronic component is shareable to the second electronic component via said system bus. By the invention it is possible that the second electronic component uses the random access memory facility of the first electronic component. Thus, it does not need its own random access memory or at least only a small one so that the overall amount of memory on the chip can be reduced. Costs for an internal or an additional external on-chip general purpose random access memory facility can be saved this way. It can thus be avoided that memories of temporarily unused components lie idle, which is inefficient. If an on-chip general purpose random access memory is omitted, less chip-area is necessary for random access memory and thus the leakage current is reduced. In summary, the essential feature of the invention is to avoid the presence of temporarily unused memories. The system-on-chip apparatus have bigger memories available on a backbone bus system for general purpose use and multiple usages. The synergies of this multiple usages can save significant amounts of memories and therefore reduce chip-area and cost as well as leakage current.

A preferred system-on-chip apparatus is provided with a central processing unit as a third electronic component. By the central processing unit, the electronic components can be efficiently controlled.

In an advantageous embodiment, the random access memory of the first electronic component is shareable to the central processing unit. This can reduce the amount of random access memory needed even though a central processing unit is present.

Preferably, a multiplexer allocates temporarily exclusive access to the random access memory of the first electronic component and/or to a general purpose random access memory between the electronic components. By using a central multiplexer, data collisions can be avoided.

Advantageously, the central processing unit serves as the multiplexer. A separate multiplexer is not necessary in this case.

Collisions while accessing the random access memory of the first electronic component can be avoided if the central processing unit can enable and disable the special purpose function of the first and the second electronic component. If the special purpose function of the first electronic component is disabled, the second electronic component can access the random access memory of the first one without being interrupted by an access or other actions of the first one.

A sophisticated embodiment comprises a general purpose random access memory that is connected to the system bus as a fourth electronic component. Such a general purpose random access memory provides a flexible storage area having short access times, for example if both the first and second electronic components are enabled and needing to perform simultaneous memory accesses.

In such an embodiment, the general purpose random access memory is preferably shareable to the first and/or the second electronic component and/or to a central processing unit via the system bus. This enables a widely shared usage between all these electronic components. Hence, the total amount of random access memory can be reduced.

Another sophisticated embodiment comprises another random access memory that is integrated into the second electronic component, being shareable to the first electronic component and/or to a central processing unit. This way, the first and second electronic component can mutually share their internal memories. This embodiment can be generalized to an embodiment where all larger random access memories, in particular internal memories of electronic components and any general purpose memories, are shareable between several or even all components of the system-on-chip via the system bus. Particularly, a set of components' internal memories can even replace a general purpose memory. This will minimize costs and the chip-area needed for random access memory. Some electronic components may even be designed without any own internal random access memory.

In a special embodiment, the first electronic component is a wireless local area network (shortly called WLAN) transceiver and the second electronic component is a transmitter and/or receiver for digital video broadcasting for handheld appliances (shortly called DVB-H) or vice versa. In this embodiment, the first and second components serve for external communication alternatively, depending on which type of communication is possible at a time, which is, for example, depending on the environment and the distance to the next radio station. The respective other component can thus be disabled so that access to its internal memory can be allocated to the active component.

In a sophisticated embodiment, advantage can be taken of special properties of the two standards. There might be periods of inactivity defined in each standard, for example for power reduction. If it can be made possible, that one standard is serviced during the inactivity of the other, the sharing of the memories of the transceivers would not even be noticed by the end user of the device.

According to the invention, the method for operating a system-on-chip that comprises at least two electronic components serving for special purpose functions and a system bus and at least one random access memory which is integrated into the first electronic component and shareable to the second electronic component via the system bus, the access to the random access memory of the first electronic component is allocated to the second electronic component when the special purpose function of the first electronic component is disabled and is revoked when the special purpose function of the second electronic component is disabled.

In the following, the invention is explained in further detail with a drawing:

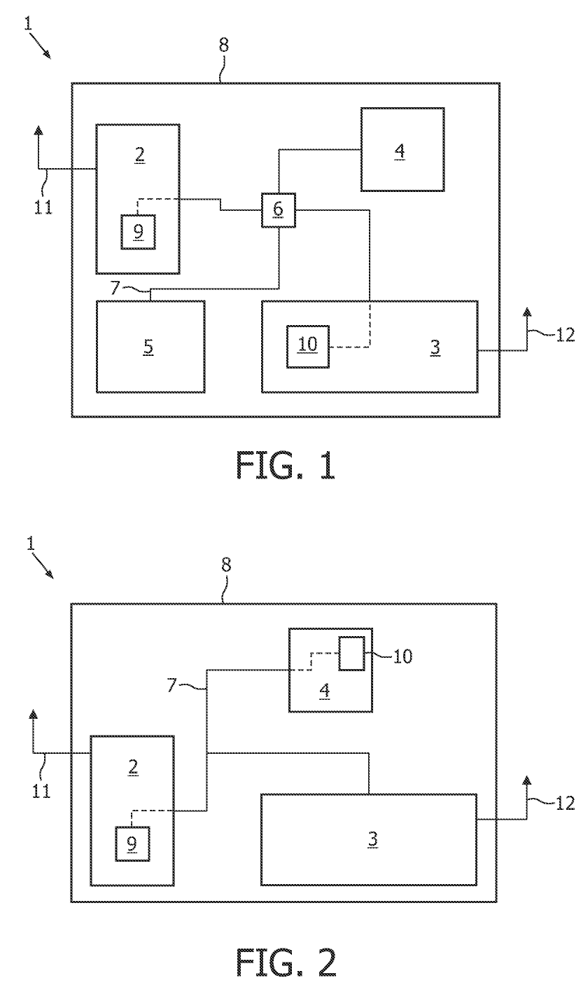

FIG. 1 shows a block diagram of a first system-on-chip apparatus, and

FIG. 2 shows a block diagram of a second system-on-chip apparatus.

The system-on-chip apparatus 1 shown in FIG. 1 comprises a first electronic component 2, a second electronic component 3, a central processing unit 4 as a third electronic component, a general purpose random access memory 5 as a fourth electronic component and a multiplexer 6 which is a part of a system bus 7, all of them arranged on a common substrate 8 as an integrated circuit.

The first electronic component 2 is a wireless local area network transceiver connected to a first external antenna 11. It contains a first internal random access memory 9 that has for instance a size of 2 MBit as a buffer for performing its special purpose communication function. The second electronic component 3 is a transceiver for digital video broadcasting for handheld appliances connected to a second external antenna 12. It contains a second internal random access memory 10 of 2 MBit which serves as a buffer for its special purpose communication function. The general purpose random access memory facility 5 of another 2 MBit stores instructions for and data of the central processing unit 4 in a section specially assigned to the central processing unit 4.

All electronic components 2, 3, 4, 5 are connected to the system bus 7. The first and second internal random access memories 9, 10 of the first and second electronic component 2, 3 and the general purpose random access memory 5 are shareable to the respective other electronic components 3, 2, 4 via the system bus 7. Such accesses from other components are exclusively allocated and controlled by the multiplexer 6. Any of the first three electronic components 2, 3, 4 can access any of the three random access memory facilities 5, 9, 10 via the multiplexer 6. While one of the electronic components 2, 3, 4 is accessing a certain memory 5, 9, 10 the multiplexer 6 blocks any access of another electronic component 2, 3, 4 to the respective memory 5, 9, 10.

The central processing unit 4, i.e. the third electronic component, can enable or disable the first and second electronic components 2 and 3 via the system bus 7 depending on, for example which one offers a stronger receive signal or which of the two services currently is requested by the user. As this way the first electronic component 2 and the second electronic component 3 are enabled and active alternatively only, the respective electronic component 2, 3 that is enabled can use both the first and second internal random access memories 9, 10. It can also use sections of the general purpose random access memory 5 when the central processing unit is not accessing its special section of the general purpose random access memory 5. The overall amount of random access memory can thus be reduced in comparison to known systems-on-chips, because the individual internal random access memories 9, 10 can be designed smaller than up to now.

The first and second and electronic components 2, 3 can, for example, use direct memory access (DMA) for accessing the random access memories 5, 9, 10.

In other embodiments, the function of the multiplexer 6 can be provided by the central processing unit 4. The central processing unit 4 is then programmed to serve for this purpose amongst others.

FIG. 2 shows a simpler system-on-chip apparatus 1 that is similar to that of FIG. 1. It comprises a first electronic component 2, a second electronic component 3, a third electronic component in form of a central processing unit 4 and a system bus 7, all of them arranged on a common substrate 8.

The first electronic component 2 is a wireless local area network transceiver connected to a first external antenna 11. It contains a first internal random access memory 9 of 3 MBit size serving as a buffer for performing its special purpose communication function. The second electronic component 3 is a transceiver for digital video broadcasting for handheld appliances connected to a second external antenna 12. It does not contain any internal random access memory. The third electronic component, i.e. the central processing unit 4, contains a second internal random access memory 10 of 1 MBit size. It stores instructions for and data of the central processing unit 4 in particular.

All electronic components 2, 3, 4 are connected to the system bus 7. The first internal random access memory 9 of the first electronic component 2 is shareable to the second electronic component 3 via the system bus 7. The central processing unit 4, i.e. the third electronic component, can enable or disable the first and second electronic components 2 and 3 via the system bus 7 alternatively depending on which one receives data from a signal source. Only the respective electronic component 2, 3 that is enabled at a time can use the first internal random access memory 9. The central processing unit 4 uses its internal second random access memory 10 only.

A general purpose random access memory is not required in this embodiment. The overall amount of random access memory is thus further reduced. Costs for an internal random access memory of the second electronic component 3 or for a general purpose random access memory facility can be saved. Besides, the chip-area of the substrate 8 can be used more efficiently this way.

In summary: There are two possibilities to share memory between the electronic components 2, 3, 4 and the system bus 7:
1. Providing the electronic component 2, 3, 4 with access to general purpose memory 5 using direct memory access mechanisms. In case the electronic component 2, 3, 4 has specific requirements regarding data reordering, the system memory may have to be optimized for this access. As long as the memory blocks of the memory 5 are reused, only some additional logic has to be added. Since the memories 5 may have a significant size; the overhead in standard cell logic is negligible.
2. Providing a bus interface to the component's internal memory 9, 10 and thus allowing access to the dedicated memories via the “backbone” system bus 7.

### LIST OF REFERENCE NUMERALS

1 System-on-chip apparatus
2 First electronic component
3 Second electronic component
4 Central processing unit
5 General purpose random access memory
6 Multiplexer
7 System bus
8 Substrate
9 First internal random access memory
10 Second internal random access memory
11 First Antenna
12 Second Antenna

1. A system-on-chip apparatus, comprising at least two electronic components serving for special purpose functions and a system bus and at least one random access memory that is integrated into the first electronic component, located in common on one substrate, wherein the system bus connects the electronic components and wherein the random access memory of the first electronic component is shareable to the second electronic component via said system bus.

2. The system-on-chip apparatus according to claim 1, comprising a central processing unit as a third electronic component.

3. The system-on-chip apparatus according to claim 2, wherein the random access memory of the first electronic component is shareable to the central processing unit.

4. The system-on-chip apparatus according to claim 3, wherein a multiplexer allocates temporarily exclusive access to the random access memory of the first electronic component and/or to a general purpose random access memory between the electronic components.

5. The system-on-chip apparatus according to claim 4, wherein the central processing unit serves as the multiplexer.

6. The system-on-chip apparatus according to claim 5, wherein the central processing unit can enable and disable the special purpose function of the first and the second electronic component.

7. The system-on-chip apparatus according to claim 6, comprising a general purpose random access memory connected to the system bus as a fourth electronic component.

8. The system-on-chip apparatus according to claim 7, wherein the general purpose random access memory is shareable to the first and/or the second electronic component and/or to a central processing unit via the system bus.

9. The system-on-chip apparatus according to claim 8, wherein another random access memory is integrated into the second electronic component, being shareable to the first electronic component and/or to a central processing unit.

10. The system-on-chip apparatus according to claim 9, wherein the first electronic component is a wireless local area network transceiver and the second electronic component is a transmitter and/or receiver for digital video broadcasting for handheld appliances or vice versa.

11. A method for operating a system-on-chip comprising at least two electronic components serving for special purpose functions and a system bus and at least one random access memory which is integrated into the first electronic component and shareable to the second electronic component via the system bus, wherein access to the random access memory the first electronic component is allocated to the second electronic component when the special purpose function of the first electronic component disabled and wherein it is revoked when the special purpose function of the second electronic component is disabled.

12. A system-on-chip apparatus according to claim 10, wherein periods of inactivity defined in the standard are utilized to serve the other standard, such that the end user experiences the two standards to be processed simultaneously.
